(19) United States
(12) Patent Application Publication
(10) Pub. No.: US 2025/0041137 A1
(43) Pub. Date: Feb. 6, 2025

(54) PATIENT SUPPORT APPARATUS HAVING GRAPHICAL USER INTERFACE USING A SERIALIZER/DESERIALIZER AND A COILED CABLE

(71) Applicant: Hill-Rom Services, Inc., Batesville, IN (US)

(72) Inventors: Maxime Emile Scolan, Kervignac (FR); Mickael Audic, Locmiquelic (FR)

(21) Appl. No.: 18/794,052

(22) Filed: Aug. 5, 2024

Related U.S. Application Data
(63) Continuation-in-part of application No. 18/763,053, filed on Jul. 3, 2024.
(63) Continuation-in-part of application No. 18/775,004, filed on Jul. 17, 2024.
(60) Provisional application No. 63/518,897, filed on Aug. 11, 2023.
(60) Provisional application No. 63/529,795, filed on Jul. 31, 2023.
(60) Provisional application No. 63/518,566, filed on Aug. 10, 2023.

(51) Int. Cl. A61G 7/05

(52) U.S. Cl. CPC A61G 7/05

(57) ABSTRACT

A video display interface includes a first component, such as a mattress, having a serializer. A second component, such as a handheld pendant controller for the mattress, includes a deserializer and an electronic component, such as graphical user interface having a touch screen display. The serializer converts a first plurality of signals into a serial data signal that is transmitted through at least one wire to the deserializer. The deserializer converts the serial data signal into the second plurality of signals that are transmitted to the electronic component.

### CROSS-REFERENCE TO RELATED APPLICATIONS

This application claims the benefit, under 35 U.S.C. § 119 (e), of U.S. Provisional Application No. 63/518,897, filed Aug. 11, 2023, and this application is a continuation-in-part of U.S. patent application Ser. No. 18/763,053, filed Jul. 3, 2024, which claims the benefit, under 35 U.S.C. § 119 (e), of U.S. Provisional Application No. 63/529,795, filed Jul. 31, 2023, and is also a continuation-in-part of U.S. patent application Ser. No. 18/775,004, filed Jul. 17, 2024, which claims the benefit under, 35 U.S.C. § 119 (e), of U.S. Provisional Application No. 63/518,566, filed Aug. 10, 2023, all of which are expressly incorporated by reference herein including the Appendices 1-4 of U.S. Provisional Application No. 63/518,897.

### BACKGROUND

The present disclosure relates to a patient support apparatus and, in particular, to a patient support apparatus having a graphical user interface using a serializer/deserializer and a coiled cable.

Some patient support apparatuses include handheld pendants having displays or screens that interface with the patient so that the patient can control operation of the patient support apparatus or devices within a patient room. Accommodating display data on a screen requires several wires to send data to the display. For example low-voltage differential signaling (LVDS) displays may include as many as 10 wires and red, green, blue (RGB) displays may include as many as 28 wires. Furthermore, 4 or more additional wires may be required for a touch screen control or a complex architecture using a microcontroller or microprocessor near the display. Accordingly, such a large number of wires are not capable of being embedded within a coiled cable of reasonably-sized cross section and therefore, non-coiled prior art cables used with control pendants of patient support apparatuses are typically quite long which potentially allows the cable to drag on the floor if not managed properly. Currently, coiled cables are not used with patient support apparatuses that include handheld control pendants having graphical user interfaces, such as touch screen displays.

### SUMMARY

The present disclosure includes one or more of the features recited in the appended claims and/or the following features which, alone or in any combination, may comprise patentable subject matter.

According to a first aspect of the disclosed embodiments, a video display interface includes a first component having a first circuit board. A microprocessor is electronically coupled to the first circuit board. A serializer is electronically coupled to the first circuit board and is configured to receive a first plurality of signals from the microprocessor. A second component includes a second circuit board. A plurality of electronic components is electronically coupled to the second circuit board. A deserializer is electronically coupled to the second circuit board and is configured to transmit a second plurality of signals to the plurality of electronic components. A coiled cable includes at least one wire. The serializer converts the first plurality of signals into a serial data signal that is transmitted through the at least one wire to the deserializer. The deserializer converts the serial data signal into the second plurality of signals. A shield surrounds the at least one wire to protect the plurality of electronic components from interference.

In some embodiments of the first aspect, at least one of the plurality of electronic components may be a video display. At least one of the plurality of first signals and at least one of the plurality of second signals may be a video signal. The video display may include a low-voltage differential signaling (LVDS) display. The video display may include a red, green, blue (RGB) display. The shield may prevent electromagnetic compatibility (EMC) perturbations on the video display. The at least one wire may include six conductive wires, only two of which may be for transmission of the serial data signal, and a drain wire. The first component may be a mattress. The second component may be a handheld pendant configured to control operation of the mattress. The first circuit board may include a first communication port. The second circuit board may include a second communication port. The coiled cable may extend between the first communication port and the second communication port. The cable may include a first connector configured to couple to the first circuit board. A second connector may be configured to couple to the second circuit board. A fixation device may be configured to couple the cable to the first component. The first connector may extend from the fixation device. A length that the first connector extends from the fixation device may be adjustable.

According to a second aspect of the disclosed embodiments, a video display interface includes a first component having a microprocessor. A serializer is configured to receive a first plurality of signals from the microprocessor. A second component includes a video display. A deserializer is configured to transmit a second plurality of signals to the video display. A coiled cable includes at least one wire. The serializer converts the first plurality of signals into a serial data signal that is transmitted through the at least one wire to the deserializer. The deserializer converts the serial data signal into the second plurality of signals. At least one of the plurality of first signals and at least one of the plurality of second signals is a video signal.

Optionally, in the second aspect, the video display may include a low-voltage differential signaling (LVDS) display. The video display may include a red, green, blue (RGB) display. The at least one wire may include six conductive wires, only two of which may be for transmission of the serial data signal, and a drain wire. The first component may be a mattress. The second component may be a handheld pendant configured to control operation of the mattress. The first component may include a first communication port. The second component may include a second communication port. The coiled cable may extend between the first communication port and the second communication port. The cable may include a first connector configured to couple to a first circuit board of the first component. A second connector may be configured to couple to a second circuit board of the second component. A fixation device may be configured to couple the cable to the first component. The first connector may extend from the fixation device. A length that the first connector extends from the fixation device may be adjustable.

According to a third aspect of the disclosed embodiments, a video display interface includes a mattress having a microprocessor. A serializer is configured to receive a first plurality of signals from the microprocessor. A handheld pendant is configured to control operation of the mattress. The handheld pendant includes a video display. A deserializer is configured to transmit a second plurality of signals to the video display. A coiled cable includes at least one wire. The serializer converts the first plurality of signals into a serial data signal that is transmitted through the at least one wire to the deserializer. The deserializer converts the serial data signal into the second plurality of signals. At least one of the plurality of first signals and at least one of the plurality of second signals is a video signal. A shield surrounds the at least one wire to prevent electromagnetic compatibility (EMC) perturbations on the video display.

In some embodiments of the third aspect, the video display may include a low-voltage differential signaling (LVDS) display. The video display may include a red, green, blue (RGB) display. The at least one wire may include six conductive wires, only two of which may be for transmission of the serial data signal, and a drain wire. The mattress may include a first communication port. The handheld pendant may include a second communication port. The coiled cable may extend between the first communication port and the second communication port. The cable may include a mattress connector configured to couple to the first communication port. A pendant connector may be configured to couple to the second communication port. A fixation device may be configured to couple the cable to the mattress. The mattress connector may extend from the fixation device. A length that the mattress connector extends from the fixation device may be adjustable.

According to a fourth aspect of the disclosed embodiments, a mattress includes an upper cover. A lower cover is configured to secure to the upper cover to form an outer layer of the mattress. A foam underlay is provided and has an opening formed therein. A control box is positioned in the opening. A plurality of bladders are positioned over the foam underlay. The foam underlay, the control box, and the plurality of bladders are secured within the outer layer of the mattress.

In some embodiments of the fourth aspect, a patient pendant may be coupled to the control box. A cable may extend from inside the outer layer of the mattress to outside the outer layer of the mattress to couple the patient pendant to the control box. The patient pendant may be positioned outside the outer layer of the mattress. The plurality of bladders may include air bladders. The plurality of bladders may include foam. A microclimate management system may be positioned above the plurality of bladders. The control box may include a fan to control a flow of air into the microclimate management system. The control box may include at least one sensor to detect a patient on the mattress. The at least one sensor may include a closed bag that is flexible and defines a chamber. When the chamber is filled with a fluid, the at least one sensor may act as a mechanical pressure transducer. The at least one sensor may include a mechanical pressure transducer. The control box may include at least one of a fan and a pump to control a flow of air into the plurality of bladders. The control box may include a manifold to control a flow of air into the plurality of bladders. A display may be provided to control various functions of the mattress. The display may include at least one screen for controlling the plurality of bladders. The plurality of bladders may be controlled to rotate a patient on the mattress. The plurality of bladders may be controlled to prevent pressure sores in a patient on the mattress. The display may include at least one screen for controlling a microclimate management system of the mattress. The display may include at least one screen for displaying a respiratory rate and heart rate of a patient on the mattress.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a patient support apparatus in accordance with an embodiment of the present disclosure;

FIG. 2 is a perspective view of a handheld pendant in accordance with an embodiment of the present disclosure, showing the handheld pendant having a handheld housing with a graphical user interface (aka a video display) and a coiled cable extending from the housing;

FIG. 3 is a block diagram of the electronics of a first embodiment of a video display interface of the present disclosure, showing a first circuit board of the interface located in a mattress and a second circuit board of the interface located in a handheld pendant and electronically coupled to the first circuit board with the coiled cable;

FIG. 4 is a block diagram of the electronics of a second embodiment of a video display interface of the present disclosure, showing the second embodiment of the interface having two handheld pendants, a first circuit board of the interface located in the mattress, and a secondary circuit board of the interface located in each of the handheld pendants and electronically coupled to the first circuit board with respective coiled cables;

FIG. 5 is a cross-sectional view of the coiled cables of the first and second interface embodiments illustrating that each coiled cable includes two twisted pair conductive wires for transmission of serial video data, and five additional conductive wires, with each of the seven wires surrounded by a dielectric material, and with a shielding material and an outer protective jacket surrounding all seven conductive wires;

FIG. 6 is a side elevation view of one of the coiled cables illustrating first and second connectors at each end of the coiled cable;

FIG. 7 is a perspective view of the first connector of the coiled cable;

FIG. 8 is a perspective view of the second connector of the coiled cable;

FIG. 9 is an exploded view of a mattress in accordance with an embodiment;

FIG. 10 is an exploded view of another mattress in accordance with an embodiment;

FIG. 11 is a schematic view of a control system in accordance with an embodiment and usable with the mattresses of FIG. 9 and FIG. 10;

FIG. 12 is an exploded view of yet another mattress in accordance with an embodiment;

FIG. 13 is a schematic view of a control system in accordance with an embodiment and usable with the mattress of FIG. 12;

FIG. 14 is a front view of a patient pendant in accordance with an embodiment and usable with the mattresses of FIG. 9, FIG. 10, and FIG. 12;

FIG. 15 is a front view of a display in accordance with an embodiment and usable with the mattresses of FIG. 9, FIG. 10, and FIG. 12

FIG. 16 is an exemplary display screen that is displayed on the display shown in FIG. 15;

FIG. 17 is another exemplary display screen that is displayed on the display shown in FIG. 15;

FIG. 18 is yet another exemplary display screen that is displayed on the display shown in FIG. 15; and

FIG. 19 is a further exemplary display screen that is displayed on the display shown in FIG. 15.

### DETAILED DESCRIPTION

For the purposes of promoting an understanding of the principles of the disclosure, reference will now be made to a number of illustrative embodiments illustrated in the drawings and specific language will be used to describe the same.

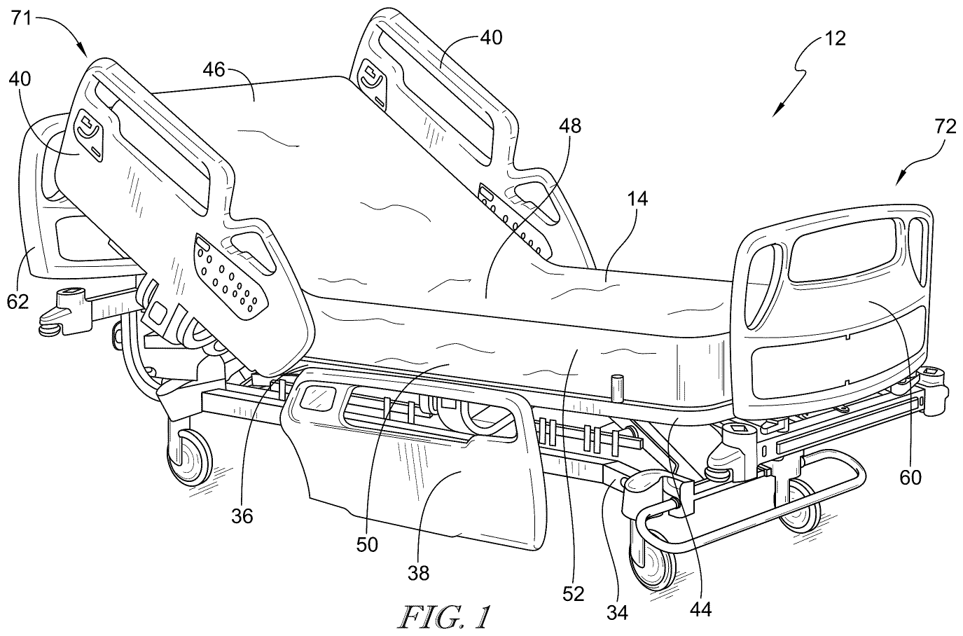

Referring to FIG. 1, a patient support apparatus 12 is embodied as a patient bed and includes a base 34 and a deck 36 that cooperate to support a mattress 14 above a floor. The base 34 is configured to raise, lower, and tilt the deck 36 relative to the floor, thereby to raise, lower, and tilt the mattress 14 relative to the floor. The deck 36 is articulatable and may be reconfigured to support a patient on the mattress 14 in a variety of positions, for example in a lie-flat position or a sit-up position (shown in FIG. 1). The patient support apparatus 12 also includes footrails 38 and headrails 40, oftentimes referred to as siderails, coupled to the deck 36 for movement between raised and lowered positions. In the illustrative example, headrails 40 are raised and footrails 38 are lowered. In the raised positions, siderails 38, 40 block a patient from accidentally rolling off of the patient support system 12. A foot board 60 is coupled to a foot end 72 of bed 12 and a headboard 62 is coupled to the head end 71 of bed 12.

The deck 36 illustratively includes a head-deck section 46, a seat-deck section 48, a thigh-deck section 50, and a foot-deck section 52. The head-deck section 46 is mounted to an upper frame 44 to pivot about an axis relative to the seat-deck section 48 and to slide relative to the seat-deck section 48 and the upper frame 44. The seat-deck section 48 is coupled to the upper frame 44 to move with the upper frame 44. The thigh-deck section 50 is coupled to the seat-deck section 48 to pivot relative to the seat-deck section 48. The foot-deck section 52 is coupled to the thigh-deck section 50 to pivot relative to the thigh-deck section 50. In some embodiments, the foot-deck section 52 is also extendable and retractable to lengthen or shorten the deck 36 as desired by a caregiver or to accommodate repositioning of the deck 36. Illustrative bed 12 shown in FIG. 1 is the Hillrom™ 900 Accella™ Smart Bed manufactured by Hill-Rom S.A.S. of Pluvigner, France.

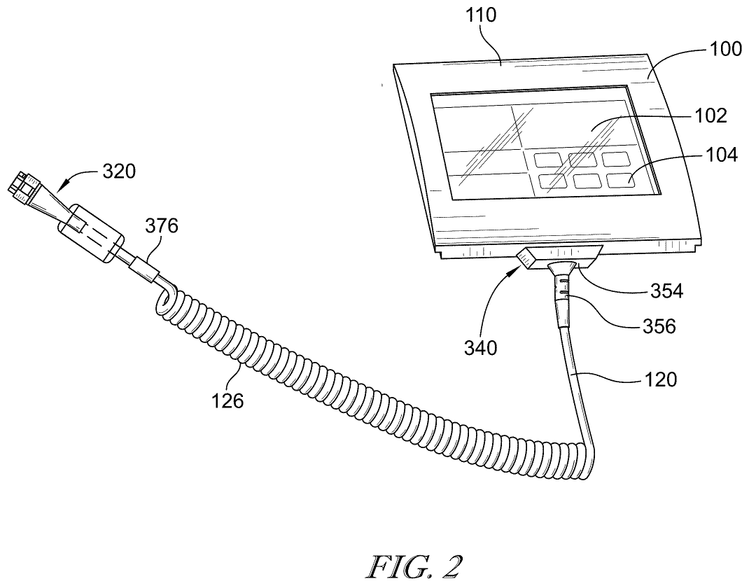

Referring now to FIG. 2 an exemplary electronic component includes handheld pendant 100 having housing 110 and a video display 102, for example a graphical user interface (GUI), built into the housing 110. The handheld pendant 100 is operable with the patient support apparatus 12. For example, the handheld pendant 100 is configured to be electronically coupled to the mattress 14 to control operation of the mattress 14. In some embodiments, the handheld pendant 100 is mountable to siderails 38, 40, headboard 62, or footboard 60 of the patient support apparatus 12 such as with a hook on the back of housing 110 or straps attached to the back of housing 110 or with any other suitable coupling mechanisms such as clamps, posts, fingers, and the like.

In some embodiments, GUI 102 receives user inputs to control operation of the patient support apparatus 12, for example movement of the deck sections 46, 48, 50, and 52. In the illustrative embodiment, however, the handheld pendant 100 is used to control features and functions of mattress 14 such as inflation and deflation of various air bladders provided within mattress 14. In some embodiments, the video display 102 includes a low-voltage differential signaling (LVDS) display. In other embodiments, the video display 102 includes a red, green, blue (RGB) display. In some embodiments, the video display 102 includes a touch screen display. The present disclosure contemplates that video display 102 includes multiple displays of the same type or combinations of the above-mentioned types of video displays in variant embodiments.

In the illustrative embodiment, video display 102 is a touch screen display that includes soft keys 104 operable as user inputs defined by various images (e.g., icons and/or buttons) shown on the video display 102. The soft keys 104, therefore, are selectable to control the various functions of the mattress 14. It will be appreciated that, in some embodiments, the handheld pendant 100 includes hard keys adjacent to video display 102 on housing 110 that are operable as user inputs to control certain functions of mattress 14 and/or to control the images shown on the video display 102. In some embodiments, the patient support apparatus 12 is positioned in a patient room (not shown) having various devices, such as a television, lighting, and adjustable curtains. It will be appreciated that, in some embodiments, the handheld pendant 100 is further operable to control at least one of the devices in the patient room.

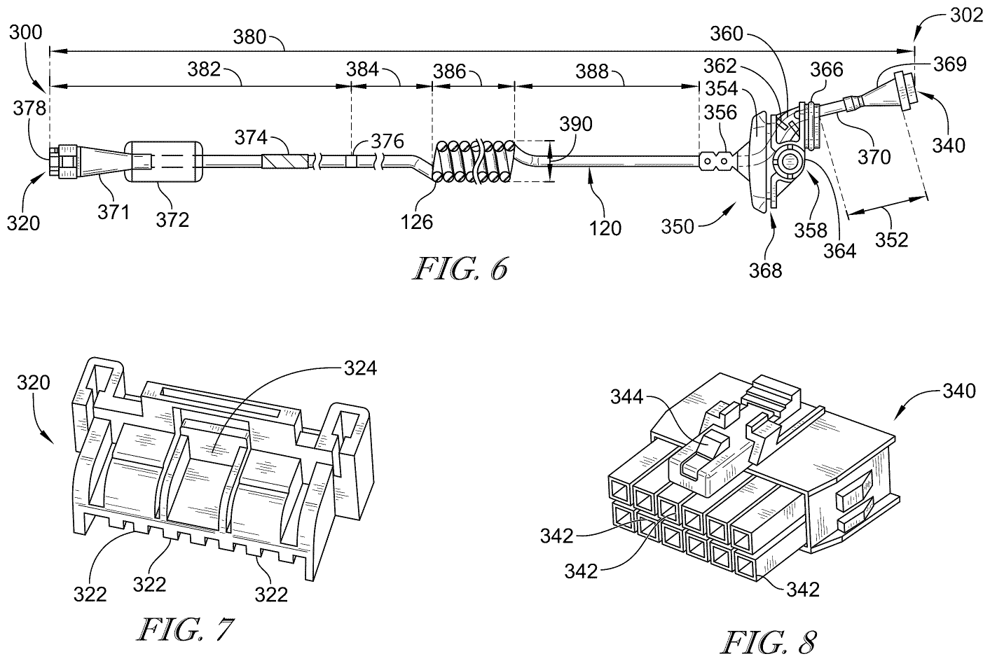

Still referring to FIG. 2, coiled cable 120 includes a coiled section 126 (sometimes referred to herein as “coil 126”) that extends from the handheld pendant 100. A detailed description of the coiled cable 120 is provided below with respect to FIG. 6. The cable 120 is configured to be electronically coupled to circuitry of the mattress 14 to enable the handheld pendant 100 communicate with the circuitry of mattress 14. The cable 120 enables the handheld pendant to control operation of the mattress 14. In some embodiments, the cable 120 transmits power from the mattress 14 to the handheld pendant 100 to power the circuitry of handheld pendant 100 and the video display 102. In another embodiment, the handheld pendant 100 has its own power source, for example a battery. The coiled section 126 in the cable 120 is expandable and retractable to allow for lengthening of cable 120 between the mattress 14 and the handheld pendant 100 when in use while shortening when not in use to reduce an amount of slack between the mattress 14 and the handheld pendant 100. The coil 126 in the cable 120 also prevents the cable 120 from dragging on the floor during transportation of the patient support apparatus 12, for example. Even while the patient support apparatus 12 is stationary, the coil 126 in the cable 120 prevents the cable 120 from resting on the floor, thereby preventing the spread of germs and bacteria via the cable 120.

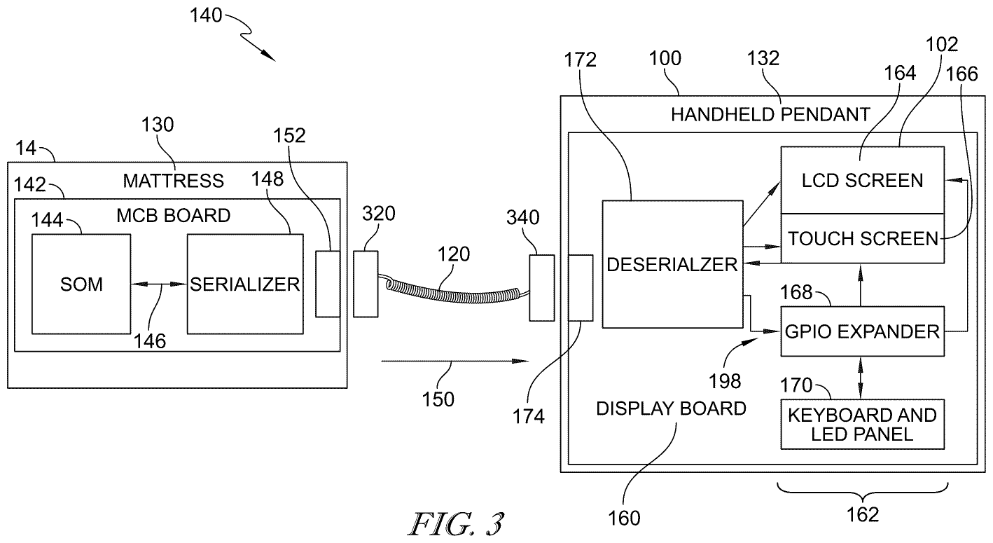

Referring now to FIG. 3, a video display interface 140 includes a first component 130 and a second component 132. In an exemplary embodiment, the first component 130 is the mattress 14 and the second component 132 is the handheld pendant 100. The first component 130 includes main control board 142 that includes a plurality of electrical components configured to control the operation of the mattress 14. A microprocessor or microcontroller 144 is carried by the main control board 142. In the illustrative embodiment, the microprocessor 144 is a system-on-module (SOM) that integrates the main elements of a processing subsystem of the main control board 142. In the illustrative embodiment, the microprocessor 144 is configured to transmit video data via a multi-line ribbon cable 146 to a serializer 148 that is also carried by the main control board 142.

In the illustrative embodiment, the multi-line ribbon cable 146 transmits LVDS signals and therefore, ribbon cable 146 includes 10 wires. In other embodiments, the multi-line ribbon cable 146 transmits RGB signals and in such embodiments, ribbon cable 146 includes 28 wires. The serializer 148 converts the video signals received over multi-line ribbon cable 146 into a serial data signal 150 or, in some embodiments, a pair of serial data signals 150. That is, the serializer 148 breaks each of the video signals received over ribbon cable 146 into individual bytes that are arranged in serial in a serial data signal 150. The serial data signal 150 is transmitted to a communication port 152 that is positioned inside of the mattress 14. In the illustrative embodiment, communication port 152 is mounted to main control board. In alternative embodiments, communication port 152 is accessible on an exterior of mattress 14 such as being mounted to an outer ticking or cover of mattress 14. In such embodiments, additional conductors are provided within mattress 14 and extend from the exteriorly accessible port 152 to main control board 142.

The second component 132 includes a display circuit board 160 having a plurality of electronic components 162 electronically coupled thereto. In some embodiments, at least one of the electronic components 162 includes the video display 102. In the illustrative embodiment, the electronic components 162 include a liquid crystal display (LCD) screen 164, a touch screen 166, a general purpose input/output (GPIO) expander 168, and a keyboard and light emitting diode (LED) panel 170. Each of the electronic components 162 is electronically coupled to a deserializer 172 that is electronically coupled to the circuit board 160. The deserializer 172 is electronically coupled to a communication port 174. In the illustrative embodiment, serializer 148 comprises a model no. DB90UB927Q-Q1 5 MHz-85 MHz 24-bit Color FPD-Link III Serializer with Bidirectional Control Channel and deserializer 172 comprises a model no. DB90U926Q-Q1 5 MHz-85 MHz 24-bit Color FPD-Link III Deserializer with Bidirectional Control Channel, both of which are available from Texas Instruments, Inc. of Dallas, Texas, U.S.A.

With continued reference to FIG. 2, coiled cable 120 extends between communication port 152 and communication port 174. In the illustrative embodiment, a non-coiled section of the coiled cable 120 extends through an opening in the mattress 14 and couples to the communication port 152 positioned within the mattress 14. A strain relief or other suitable grommet is provided within the mattress opening and the cable 120 passes through the strain relief or grommet such as with a press fit therebetween and/or suitable adhesive or other fastener to affix the cable 120 and strain relief or grommet together. The non-coiled section of cable 120 is primarily situated inside of mattress 14 and the coiled section 126 of cable 120 is primarily situated outside of mattress 14.

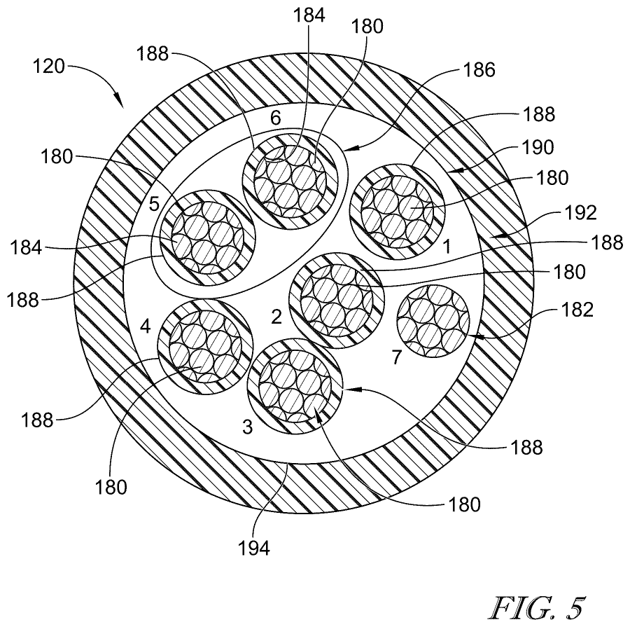

Referring now to FIG. 5, a cross-section of the coiled cable 120 is shown. Cable 120 includes six conductive wires 180 and a drain wire 182. In some embodiments, the wires 180 and 182 are formed from aluminum, copper, and/or high-strength alloys. Two of wires 180 are designated as video wires 184 and are formed as a twisted pair 186 in the illustrative embodiment. It is these two wires 184 that are used for transmission of the serial data signal. In some embodiments, the twisted pair 186 includes a yellow wire and a green wire. Drain wire 182 serves as an electrical ground wire for a shield 190 of cable 120. Shield 190 is discussed in further detail below.

The other four wires 180 extending between the first component 130 and the second component 132 within cable 120 include a ground (aka Vss) wire; a power wire which provides +24 Volt direct current (VDC) from mattress 14 to pendant 100; a CPR button wire to signal the MCB 142 of mattress 14 that a CPR button on pendant 100 has been selected (e.g., via a soft key on display 102) or pressed (e.g., via a hard key on housing 100) causing air bladders of mattress 14 to either max inflate to maximum pressures or to completely deflate, so that, in either case, the effectiveness of cardiopulmonary resuscitation (CPR) to be applied to the patient is enhanced; and a CPR light emitting diode (LED) wire to receive a signal from MCB 142 to turn on a CPR LED of pendant 100, thereby to indicate that the CPR button of handheld pendant 100 has been pressed or selected.

The present disclosure contemplates that handheld pendant 100 is devoid of any microprocessor or microcontroller such that all software processing for handheld pendant 100 is done by circuitry within mattress 14, such as by SOM 144 of MCB 142. Thus, in some embodiments, SOM 144 receives the signal on CPR button wire of cable 120 indicating that the CPR button of pendant 100 has been selected or pressed and, in response, sends a signal on CPR LED wire to turn on the CPR LED of pendant 100. In some embodiments, either or both of the CPR button and CPR LED are mounted on keyboard and LED panel 170.

By use of serializer 148 and deserializer 172 in interface 140, only two wires 184 need to be used in cable 120 for communication of serial data signals in connection with the video images to be shown on video display 102. Accordingly, the reduction in the number of wires 180 used in cable 120 facilitates coiling the cable 120. That is, cable 120 does not have the 10 wires normally used in connection with LVDS displays and/or the up to 28 wires normally used in connection with RGB displays, thereby allowing cable 120 to be coiled.

Still referring to FIG. 5, each wire 180 is individually insulated with a dielectric material 188 and all seven wires 180, 182 are collectively surrounded by a shield 190. The shield 190 forms a common conductive layer around the wires 180, 182 for electromagnetic shielding. In some embodiments, the shield 190 is a foil type shield, for example metallized film. In some embodiments, the shield 190 is formed from aluminum foil. In other embodiments, the shield 190 includes contraspiralling wire strands that are braided, unbraided, or both. The shield 190 acts as a Faraday cage that reflects electromagnetic radiation which reduces the interference from outside noise onto the signals 150 and also reduces the signals 150 from radiating out and potentially disturbing other devices, for example the video display 102. The shield 190 is wrapped with an insulating jacket 192, for example a jacket formed from plastic, that forms the outermost layer of the cable 120. As noted above, shield 190 is electrically coupled to drain wire 182 to provide an electrical ground therefor.

Referring now to FIG. 6, the cable 120 extends between a mattress end 300 and a pendant end 302. The mattress end 300 is configured to couple to communication port 152 provided on the MCB 142 inside the mattress 14. Similarly, the pendant end 302 of cable 120 is configured to couple to communication port 174 provided on the display board 160 inside the handheld pendant 100. The coiled section 126 is located in the cable 120 between the mattress end 300 and the pendant end 302. The coiled section 126 has any suitable length for connecting the handheld pendant 100 to the mattress 14. That is, the coiled section 126 is extendable so that a total length of the cable 120 is comfortably usable by a caregiver standing next to bed 12 while controlling the mattress 14. The coiled section 126 provides the appropriate length of cable 120, while preventing the cable 120 from touching or dragging on the floor when the coiled section 126 is retracted, such as during non-use when the pendant 100 is stored on one of footrails 38 or on footboard 60 of bed 12.

A pendant connector 340 is provided on the pendant end 302 of the cable 120. The pendant connector 340 is configured to mate with communication port 174 which is mounted on display board 160 as noted above. That is, the pendant connector 340 is configured to plug into communication port 174 of the pendant 100. As shown in FIG. 8, the pendant connector 340 has eight pin-receiving sockets 342 (the pin-receiving sockets 342 are sometimes simply referred to as “pins” in the art). In the illustrative embodiment having seven wires 180, 182 in cable 120, therefore, one of the eight pins 342 of connector 340 is not used to make any electrical connection between the pendant connector 340 and the display board 160. Also in the illustrative embodiment, the pendant connector 340 includes a lock 344, in the form of a flexible snap finger, to secure the pendant connector 340 to the communication port 174 of the pendant 100. It should be appreciated that communication port 174 comprises a mating connector having eight pins that are received in respective pin-receiving sockets 342 when connector 340 is attached to communication port 174. Illustrative connector 340 is a model no. 502439-0800 CLIK-Mate™ Wire-to-Board Connector available from Molex LLC of Lisle, Illinois, U.S.A. Therefore, illustrative connector 340 has a pitch, defined as a perpendicular distance measured from a longitudinal centerline of one pin-receiving socket (or pin) to the longitudinal centerline of the next pin-receiving socket (or pin), of about 2.0 mm in the illustrative embodiment.

As shown in FIG. 6, cable 120 includes a pendant fixation device 350 which is configured for receipt in an opening formed in housing 110 of pendant 100 to generally seal the opening. The pendant fixation device 350 is positioned between the coiled section 126 and the pendant connector 340. Pendant fixation device 350 includes an external escutcheon 354; an external strain relief 356 extending from a middle region of escutcheon 354; an internal cable guide 358; and an internal strain relief 360 situated within a U-shaped channel defined by first, second, and third portions 362, 364, 366 of the internal cable guide 358. A groove 368 is formed in pendant fixation device 350 at the junction between external escutcheon 354 and cable guide 358. Groove 368 is sized for receipt of wall portions of housing 110 of pendant 100 therein. For example, in some embodiments, housing 110 is constructed in a clam shell type of arrangement with first and second molded shells of housing 110 each formed with a half-opening or notch that receives a portion of device 350 therein such that wall portions around the edges of the half-openings are received in corresponding portions of groove 368.

In some embodiments, external escutcheon 354, strain relief 356, internal cable guide 358, and strain relief 360 are molded integrally with each other such that pendant fixation device 350 is a monolithic, unitary molded component. Escutcheon 354 and strain relief 356 are located outside of the interior region of housing 110 of pendant 100, whereas cable guide 358 and strain relief 360 are located inside the interior region of housing 110 of pendant 100. In some embodiments, pendant fixation device 350 is made of ultraviolet (UV) stabilized polyvinyl chloride (PVC) material having a Shore A hardness of about 80 plus or minus (+/−) about 5. Still referring to FIG. 6, portion 366 of cable guide 358 is offset from a central region of escutcheon 354 in a lateral direction (e.g., upwardly in the orientation shown in FIG. 6), with the central region of escutcheon 354 being defined as the region of escutcheon 354 from which strain relief 356 extends. Thus, cable 120 is routed through strain relief 356, escutcheon 354, and cable guide 358 along a somewhat S-shaped path.

A stub portion 370 of cable 120 extends outwardly from portion 366 of cable guide 358 at a slight inclined angle (e.g., on the order of about 5° to about 10°) relative to a front face of portion 366 and the individual wires 180, 182 contained within cable 120, along with the associated dielectric material 188 surrounding wires 180, each extend even further outwardly from a distal end of stub portion 370 for connection to respective pins 342 of pendant connector 340. A heat shrink wrap is added around drain wire 182 between the distal end of stub portion 370 and pendant connector 340. An additional heat shrink wrap 369 of similar material surrounds all of wires 180, 182 as well. In some embodiments, the heat shrink wrap is model no. 86750 tape which includes a metallized fabric (polyester Ni/Cu) coated with a pressure sensitive adhesive and which is available from Laird Technologies, Inc. of Chesterfield, Missouri, U.S.A.

As shown in FIG. 6, pendant connector 340 is situated distally outwardly from the pendant fixation device 350. In some embodiments, a distance 352 between portion 366 of cable guide 350 and a rear surface of pendant connector 340 is adjustable so that the pendant connector 340 can reach and attach to the communication port 174 on display board 160. In such embodiments, the length 352 is adjustable by sliding the pendant fixation device 350 along the cable 120. In other embodiments, pendant fixation device 350 is adhered to, or otherwise affixed to, cable 120 such that length 352 is about 45 millimeters (mm), plus or minus about 5 mm. Stub portion 370 extends about half of distance 352 from portion 366 of device 350 in such embodiments with wires 180, 182 extending outwardly from stub portion 370 to connector 340 about half of the remaining distance.

With continued reference to FIG. 6, a mattress connector 320 is provided on the mattress end 300 of the cable 120. The mattress connector 320 is configured to mate with communication port 152 which is mounted on MCB 142 of the mattress 14 as noted above. That is, the mattress connector 320 is configured to plug into communication port 152 of the mattress 14. As shown in FIG. 7, the mattress connector 320 has 12 pin-receiving sockets or pins 322. In an illustrative embodiment having seven wires 180, 182 in cable 120, therefore, five of the 12 pins 322 are not used to make any electrical connection between the mattress connector 320 and the MCB 142. Also in the illustrative embodiment, the mattress connector 320 includes a lock 324, in the form of a flexible snap finger, to secure the mattress connector 320 to the communication port 152 of the mattress 14. It should be appreciated that communication port 152 comprises a mating connector having 12 pins that are received in respective pin-receiving sockets 342 when connector 320 is attached to communication port 152. Illustrative connector 320 is a model no. 105308-1212 NANO-FIT™ Receptacle Housing available from Molex LLC of Lisle, Illinois, U.S.A. Therefore, illustrative connector 320 has a pitch of about 2.5 mm in the illustrative embodiment.

Adjacent to connector 320, some or all of wires 180, 182 are covered with a heat shrink wrap 371 such as model no. 86750 tape from Laird Technologies, Inc. of the type mentioned hereinabove. A ferrite core 372 is mounted to cable 120 so as to cover a portion of the heat shrink wrap 371 and a portion of the insulating jacket 192 of cable 120 at the mattress end 300 thereof. The shield 194 of cable 120 is pulled back over the exterior of the insulting jacket 190 of cable 120 by about 10 mm and contacts the inner surface of a bore defined in ferrite core 372. In the illustrative embodiment, ferrite core 372 is a model no. HFA150068-0A2 High Frequency EMI Split/Snap-On Ferrite Cable Core which is also available from Laird Technologies, Inc. Between ferrite core 372 and coiled section 126, cable 120 includes a part number label 374 for cable 120 and an assembly marking 376 which indicates the location at which cable 120 is to exit from mattress 14. Thus, marking 376 is received in, or is adjacent to, the strain relief or grommet through which cable 120 passes from the interior of mattress to the exterior. Label 374 may be attached to cable 120 at any location between marking 376 and ferrite core 372.

In the illustrative embodiment of cable 120, an overall length 380 of cable 120 from a front face 378 of connector 320 to a first pin-receiving socket 342 of connector 340 is about 1342 mm plus or minus (+/−) about 50 mm. Furthermore, a distance 382 from front face 378 of connector to a midpoint of marking 376 is about 365 mm+/−about 10 mm, and a distance from the midpoint of marking 376 to coiled section 126 is about 460 mm+/−about 20 mm. Thus, the distance from front face 378 of connector 320 to coiled section 126 is about 825 mm+/−about 30 mm. When coiled section 126 is retracted, it occupies a length of about 300 mm+/−about 30 mm and has an outside diameter 390 of about 22 mm+/−5 mm. A distance 388 from coiled section 126 to an end of strain relief 356 distal from escutcheon 354 is about 100 mm+/−20 mm.

With continued reference to FIG. 6, the portions of cable 120 to the right and to the left of coiled section 126 are un-coiled sections of cable 120. Moreover, while the uncoiled sections of cable 120 have straight configurations in FIG. 6, it should be appreciated that all portions of the coiled section 126 and the un-coiled sections are flexible. The dimensions given for cable 120 are simply those of the illustrative embodiment and other embodiments having different such dimensions are within the scope of the present disclosure. However, based on the disclosed dimensions, it can be seen that dimension 386 is about three times that of dimension 388 and that dimension 386 is about 22% of dimension 380. All other such comparisons between dimensions 380, 382, 384, 386, 388, 390, as well as with regard to dimension 352, can similarly be made.

Referring back to FIG. 3, the wires 190 transmit the serial data signals 150 between the first component 130 and the second component 132 and the serial data signals 150 are then transmitted to the deserializer 172. The deserializer 172 separates the serial data signals 150 into a plurality of signals 198. That is, the bytes of the serial data signals 150 are separated and reconstructed as the plurality of signals 198, which reconstruct the video data. In the illustrative example, signals 198 include an RGB signal and an I2C signal. Accordingly, the serializer 148 and the deserializer 172 enable the video data to be transmitted over the coiled cable 120 as serial data signals 150. Because only serial data signals 150 are transmitted over the coiled cable 120, fewer wires 190 are required, thereby allowing the cable 120 to be coiled. The shield 194 surrounding the wires 190 protects the plurality of electronic components 162 of display board 160 from interference thereby preventing, for example, electromagnetic compatibility (EMC) perturbations on the video display 102.

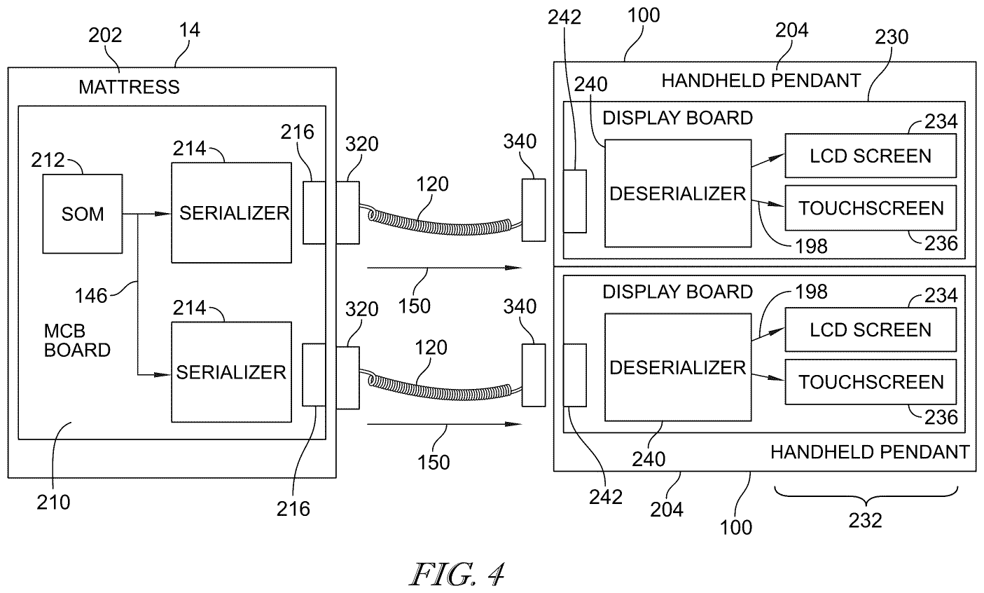

Referring now to FIG. 4, another embodiment of a video display interface 200 includes a first component 202 and a pair of second components 204. In the exemplary embodiment, the first component 202 includes the mattress 14 and the second components 204 each include handheld pendants 100. The first component 202 includes main control board 210 having a microprocessor or microcontroller 212 similar to the microprocessor 144 of the video display interface 140 of FIG. 3. However, the first component 202 also includes a pair of serializers 214 that are each coupled to a respective communication port 216.

Each second component 204 includes a respective display circuit board 230 having a plurality of electronic components 232, for example an LED screen 234 and a touch screen 236. The plurality of electronic components 232 are each electrically coupled to a respective deserializer 240 that is coupled to a respective communication port 242.

A cable 120 extends between the first component 202 and each of the second components 204 to enable the microprocessor 212 to transmit video data between the first component 202 and each second component 204, as described above with respect to the video display interface 140. Accordingly, in such an embodiment, the mattress 14 is operable with a pair of handheld pendants 100.

It will be appreciated that any number of handheld pendants 100 may be operable with the mattress 14. It will also be appreciated that the video display interfaces 140 and 200 are operable to send signals from the handheld pendant 100 to the mattress 14, in some embodiments. That is, in some embodiments, the cable 120 is operable to transmit signals both from the mattress 14 to the handheld pendant 100 and from the handheld pendant 100 to the mattress 14. In some embodiments, the handheld pendant 100 is equipped with a serializer and the mattress 14 is equipped with a deserializer to accommodate transmitting video signals from the handheld pendant 100 to the mattress 14.

In some embodiments, mattress 14 is either the Baxter® Hillrom® Syntheto™ Hybrid mattress or the Baxter® Therapy2™ Air mattress, each of which is manufactured by Hill-Rom S.A.S. of Pluvigner, France.

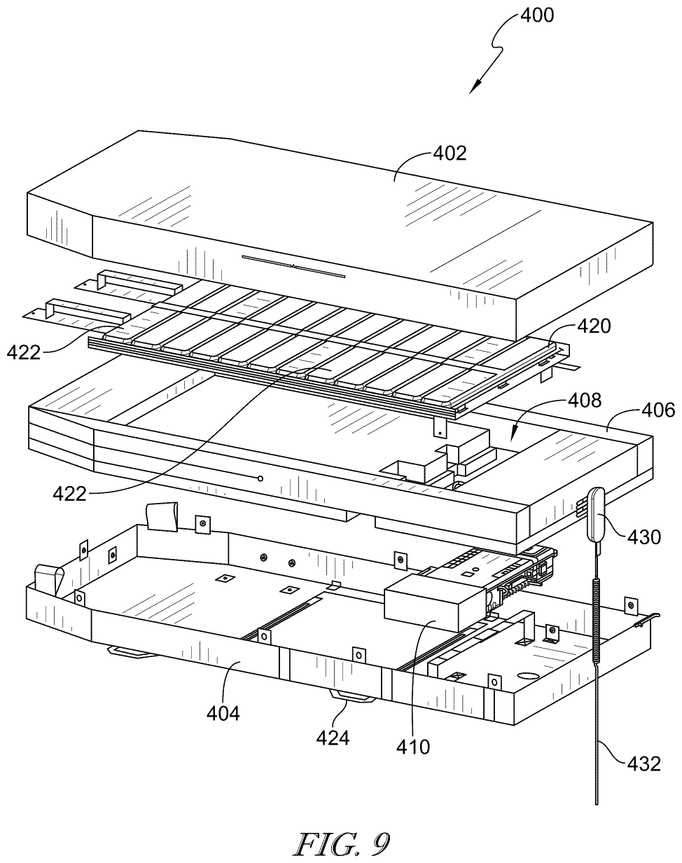

FIG. 9 illustrates a mattress 400 that is an embodiment of the mattress 14. The mattress 400 includes an upper cover 402 and a lower cover 404 configured to secure to the upper cover 402 to form an outer layer of the mattress 400. A foam underlay 406 is configured to be sealed in the outer layer. The foam underlay 406 has an opening 408 formed therein. A control system or control box 410 is positioned in the opening 408 of the foam underlay 406. A power cord (not shown) extends from the control system 410 and through the lower cover 404 to provide power to the control system 410 when plugged into an outlet. A therapeutic mattress 420 is positioned over the foam underlay 406. The therapeutic mattress 420 includes a plurality of bladders 422. In some embodiments, the plurality of bladders 422 are a combination of air and foam bladders. In some embodiments, the plurality of bladders 422 are air bladders. In some embodiments, the therapeutic mattress 420 includes 12 bladders 422. The foam underlay 406, the control system 410, and the therapeutic mattress 420 are secured within the outer layer of the mattress when the upper cover 402 is secured to lower cover 404.

Evacuation/transport handles 424 extend from the lower cover 404. The mattress is fitted with evacuation grips that are intended to facilitate the evacuation of a patient, only in an emergency. The evacuation handles are located on each side of the mattress. Caregivers should check that the handles are not in the articulated zones of the bed and that they are easily accessible. In the event of evacuation, the user undoes the straps that attach the mattress to the bed. The mattress is disconnected from the wall outlet. Three beeps sound and a message appears and the mattress automatically switches to transport mode.

A patient pendant or control pendant 430 is coupled to the control system 410. The patient pendant 430 is an embodiment of the pendant 100. A cable 432 extends from inside the outer layer of the mattress 400 to outside the outer layer of the mattress 400 to couple the patient pendant 430 to the control system 410. The cable 432 is an embodiment of the cable 120. The patient pendant 430 is positioned outside the outer layer of the mattress 400 and is configured to control various functions of the mattress 400.

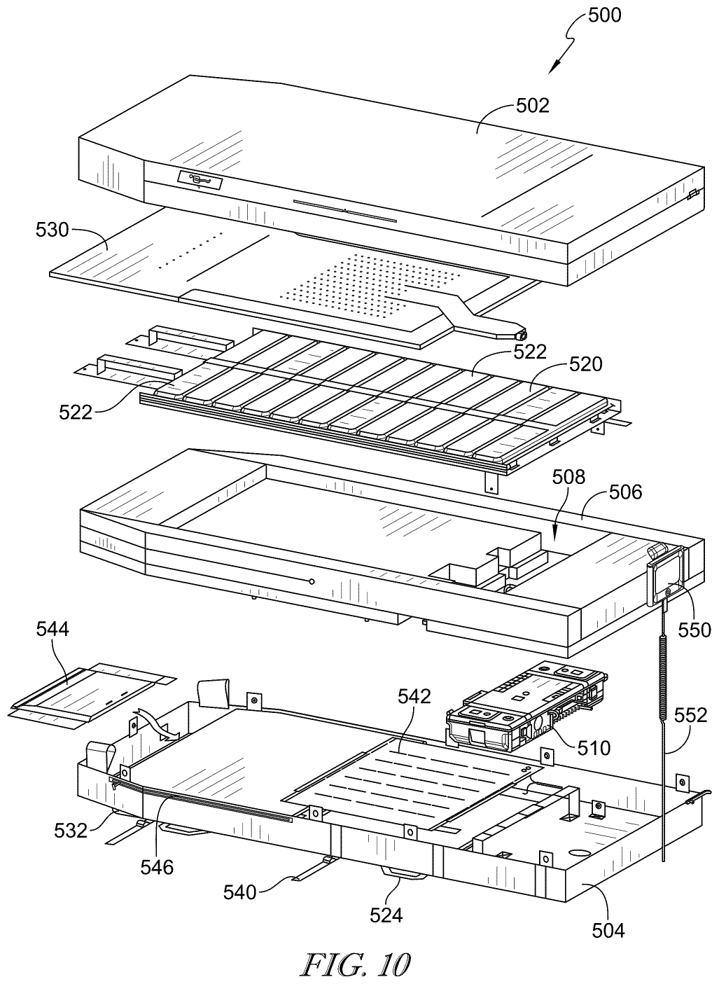

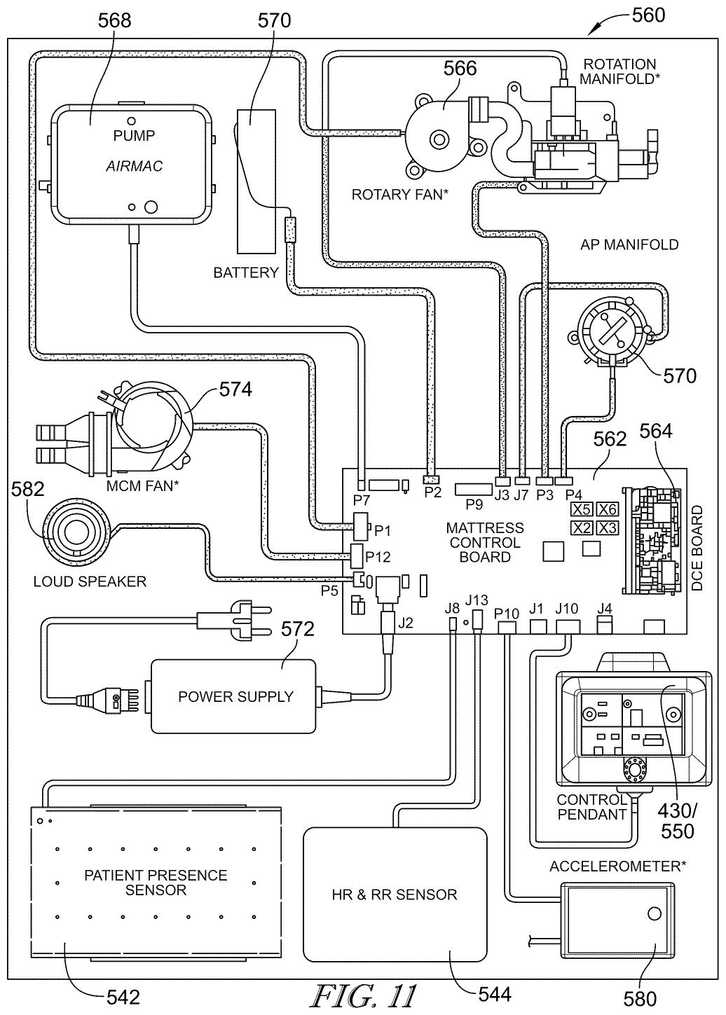

Referring to FIG. 10, another mattress 500 is an embodiment of the mattress 14. Mattress 500 includes an upper cover 502 and a lower cover 504 configured to secure to the upper cover 502 to form an outer layer of the mattress 500. A foam underlay 506 is configured to be sealed in the outer layer. The foam underlay 506 has an opening 508 formed therein. A control system or control box 510 is positioned in the opening 508 of the foam underlay 506. A power cord (not shown) extends from the control system 510 and through the lower cover 504 to provide power to the control system 510 when plugged into an outlet. A therapeutic mattress 520 is positioned over the foam underlay 506. The therapeutic mattress 520 includes a plurality of bladders 522. In some embodiments, the plurality of bladders 522 are a combination of air and foam bladders. In some embodiments, the plurality of bladders 522 are air bladders. In some embodiments, the therapeutic mattress 520 includes 12 bladders 522. A microclimate management system 530 is positioned above the therapeutic mattress 520. The foam underlay 506, the control system 510, the therapeutic mattress 520, and the microclimate management system 530 are secured within the outer layer of the mattress when the upper cover 502 is secured to lower cover 504. Patient rotation bladders 532 are positioned under the lower cover 504 and configured to be inflated and deflated to rotate the patient. Evacuation/transport handles 524 extend from the lower cover 504. Additionally, restraining straps 540 extend from the lower cover 504.

A patient presence sensor 542 is positioned under the foam underlay 506 and is configured to detect the weight of the patient to determine whether a patient is positioned on the mattress 500. A heart rate and respiratory rate sensor 544 is also positioned under the foam underlay 506 and is configured to detect the heart rate and respiratory rate of the patient. The lower cover 504 further includes an x-ray pouch or sleeve 546 formed therein for receiving an x-ray cassette. In some embodiments, the head end of the mattress is equipped with the pouch 546 for X-ray cassettes to take X-ray images. The type of materials, the density and the thickness of the mattress, and the weight and morphology of the patient can affect the quality of the X-ray images. The best way to produce X-rays of an optimal quality is to get as close to the patient as possible. The radiologist is responsible for deciding on the best solution to take the X-ray according to the medical target and the hospital's protocol adapted to the patient's illness. The X-ray cassette is placed in a cover or equivalent device to protect it before it is installed in the mattress. Radiographic images are taken in foam mode. The rotation function that may be active is stopped before installing an X-ray cassette. The X-ray cassette can be installed on the left side or the right side of the head section once the corresponding siderail has been lowered.

A patient pendant or control pendant 550 is coupled to the control system 510. The patient pendant 550 is an embodiment of the pendant 100. A cable 552 extends from inside the outer layer of the mattress 500 to outside the outer layer of the mattress 500 to couple the patient pendant 550 to the control system 510. The cable 552 is an embodiment of the cable 120. The patient pendant 550 is positioned outside the outer layer of the mattress 500 and is configured to control various functions of the mattress 500.

Referring to FIG. 11, a control system 560 can be used as the control system 410 or the control system 510 and is usable with any embodiments of the mattress 14 described herein. The illustrative control system 560 includes a main control board 562 having a processor 564 configured to carry out instructions to control the mattress 14. The main control board 662 is an embodiment of the main control board 142 and the main control board 210. A battery 570 and a power supply 572 are configured to power the various components of the control system 560. The control system 560 includes a fan 566 and a pump 568 to control a flow of air into the plurality of bladders 422/522. The fan 566 is coupled to a manifold 570 that controls the flow of air into the individual bladders 422/522. In some embodiments, a fan 574 is provided to control a flow of air into the microclimate management system 530.

In some embodiments, the control system 560 includes the patient presence sensor 542 to detect a patient on the mattress 500. In some embodiments, the patient presence sensor 542 includes a closed bag that is flexible and defines a chamber, wherein, when the chamber is filled with a fluid, the patient presence sensor 542 acts as a mechanical pressure transducer. In some embodiments, the patient presence sensor 542 includes a mechanical pressure transducer. In some embodiments, the control system 560 includes the heart rate and respiratory rate sensor 544. In some embodiments, the control system 560 includes an accelerometer 580 to determine an orientation of the mattress 400/500. In some embodiments, the control system 560 includes a speaker 582 for providing audible alerts. The control pendant 100 is coupled to the control system 560.

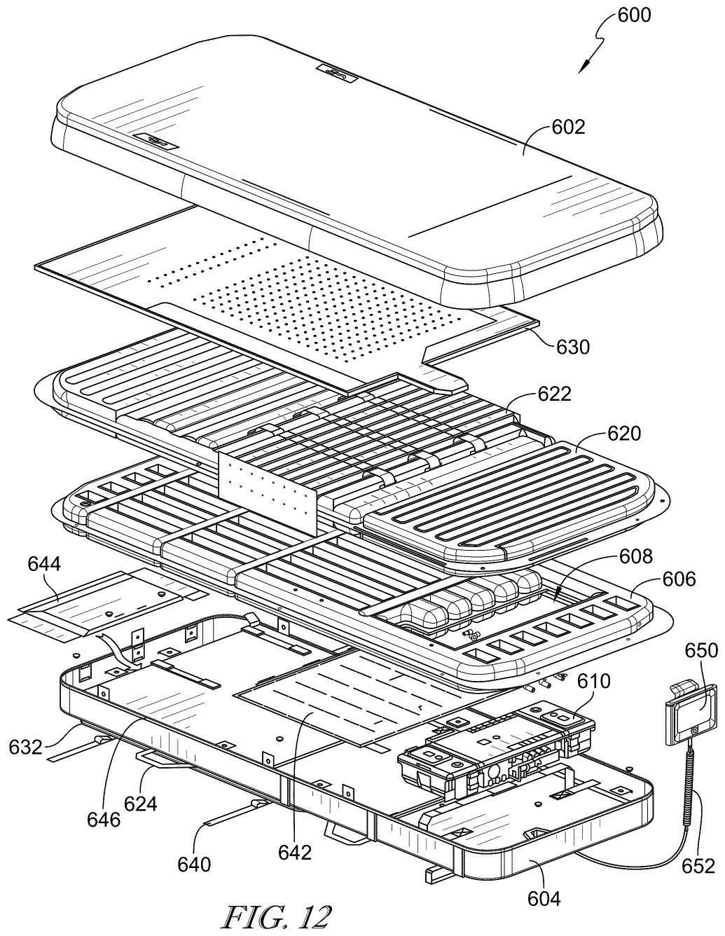

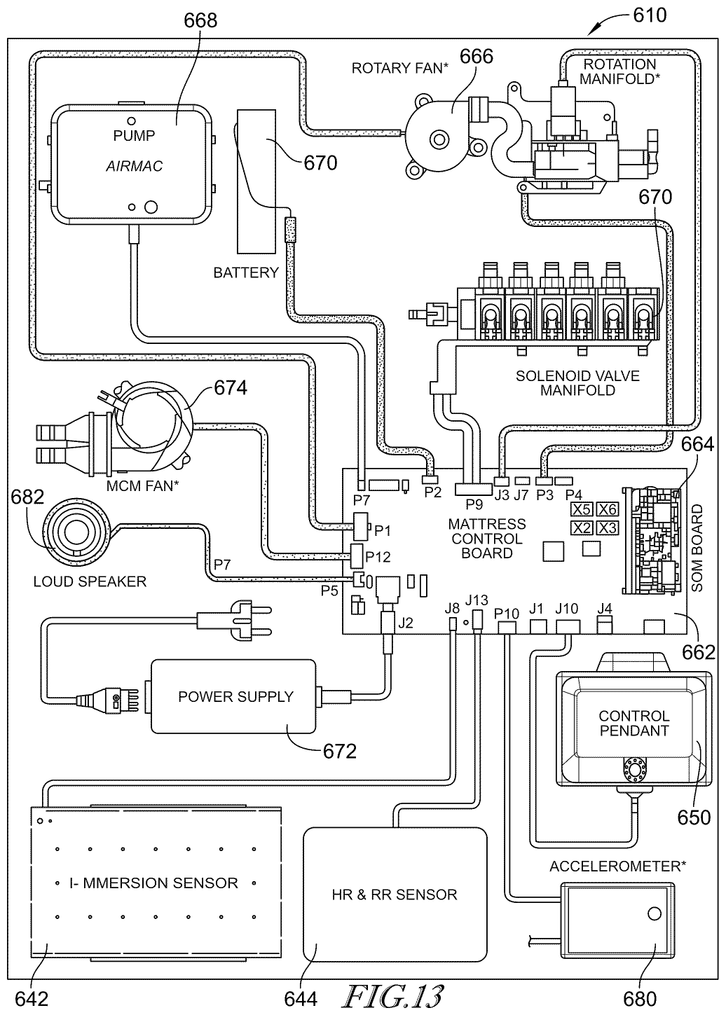

Referring now to FIG. 12, another mattress 600 is an embodiment of mattress 14. Mattress 600 includes an upper cover 602 and a lower cover 604 configured to secure to the upper cover 602 to form an outer layer of the mattress 600. A foam underlay 606 is configured to be sealed in the outer layer. The foam underlay 606 has an opening 608 formed therein. A control system or control box 610 is positioned in the opening 608 of the foam underlay 606. A power cord (not shown) extends from the control system 610 and through the lower cover 604 to provide power to the control system 610 when plugged into an outlet. A therapeutic mattress 620 is positioned over the foam underlay 606. The therapeutic mattress 620 includes a plurality of bladders 622. In some embodiments, the plurality of bladders 622 are a combination of air and foam bladders. In some embodiments, the plurality of bladders 622 are air bladders. In an exemplary embodiment, the therapeutic mattress 620 includes five zones: a head zone having four bladders in some embodiments, a back zone having five bladders in some embodiments, a sacrum zone having eight bladders in some embodiments, a thigh zone having two bladders in some embodiments, and a heel zone having 11 bladders in some embodiments.

A microclimate management system 630 is positioned above the therapeutic mattress 620. The foam underlay 606, the control system 610, the therapeutic mattress 620, and the microclimate management system 630 are secured within the outer layer of the mattress when the upper cover 602 is secured to lower cover 604. Patient rotation bladders 632 are positioned under the lower cover 604 and configured to be inflated and deflated to rotate the patient. Evacuation/transport handles 624 extend from the lower cover 604. Additionally, restraining straps 640 extend from the lower cover 604. A patient presence sensor 642 is positioned under the foam underlay 606 and is configured to detect the weight of the patient to determine that a patient is positioned on the mattress 600. A heart rate and respiratory rate sensor 644 is also positioned under the foam underlay 606 and is configured to detect the heart rate and respiratory rate of the patient. The lower cover 604 further includes an x-ray pouch or sleeve 646 formed therein for receiving an x-ray cassette.

A patient pendant or control pendant 650 is coupled to the control system 610. The patient pendant 650 is an embodiment of the pendant 100. A cable 652 extends from inside the outer layer of the mattress 600 to outside the outer layer of the mattress 600 to couple the patient pendant 650 to the control system 610. The cable 652 is an embodiment of the cable 120. The patient pendant 650 is positioned outside the outer layer of the mattress 600 and is configured to control various functions of the mattress 600.

Referring to FIG. 13 the control system 610 can be used with any of the embodiments of the mattress 14 described herein. The illustrative control system 610 includes a main control board 662 having a processor 664 configured to carry out instructions to control the mattress 14. The main control board 662 is an embodiment of the main control board 142 and the main control board 210. A battery 670 and a power supply 672 are configured to power the various components of the control system 610. The control system 610 includes a fan 666 and a pump 668 to control a flow of air into the plurality of bladders 622. The fan 666 is coupled to a solenoid valve manifold 670 that controls the flow of air into the individual bladders 622. In some embodiments, a fan 674 is provided to control a flow of air into the microclimate management system 630.

In some embodiments, the control system 610 includes the patient presence sensor 642 to detect a patient on the mattress 14. In some embodiments, the patient presence sensor 642 includes a closed bag that is flexible and defines a chamber, wherein, when the chamber is filled with a fluid, the patient presence sensor 642 acts as a mechanical pressure transducer. In some embodiments, the patient presence sensor 642 includes a mechanical pressure transducer. In some embodiments, the control system 610 includes the heart rate and respiratory rate sensor 644. In some embodiments, the control system 610 includes an accelerometer 680 to determine an orientation of the mattress 600. In some embodiments, the control system 610 includes a speaker 682 for providing audible alerts. The control pendant 100 is coupled to the control system 610.

In some embodiments, the mattresses described herein include radio equipment that operates between and including about 2.4 GHz to about 5 GHz to wirelessly transmit mattress data to a network of the healthcare facility. In some embodiments, a maximum radio-frequency power in which the radio equipment operates is in a frequency band between about 17 dBm and about 21 dBm. In some embodiments, the mattresses described herein detect a heart rate between about 30 beats per min and about 170 beats per min with a precision of about +6 beats per min and an accuracy of about 95% when the patient is in a flat position. In some embodiments, the mattresses described herein detects a respiratory rate between about 30 breaths per min and about 45 breaths per min with a precision of about +5 breaths per min and an accuracy of about 95% when the patient is in a flat position. For an immobile and silent patient, with the mattress in alternating pressure mode, with or without a microclimate management system, and without any bed articulations, about 95% of measurements have a precision of six heart beats and five breaths per minute, compared with oxymetry and capnography measurements of a vital signals monitor.

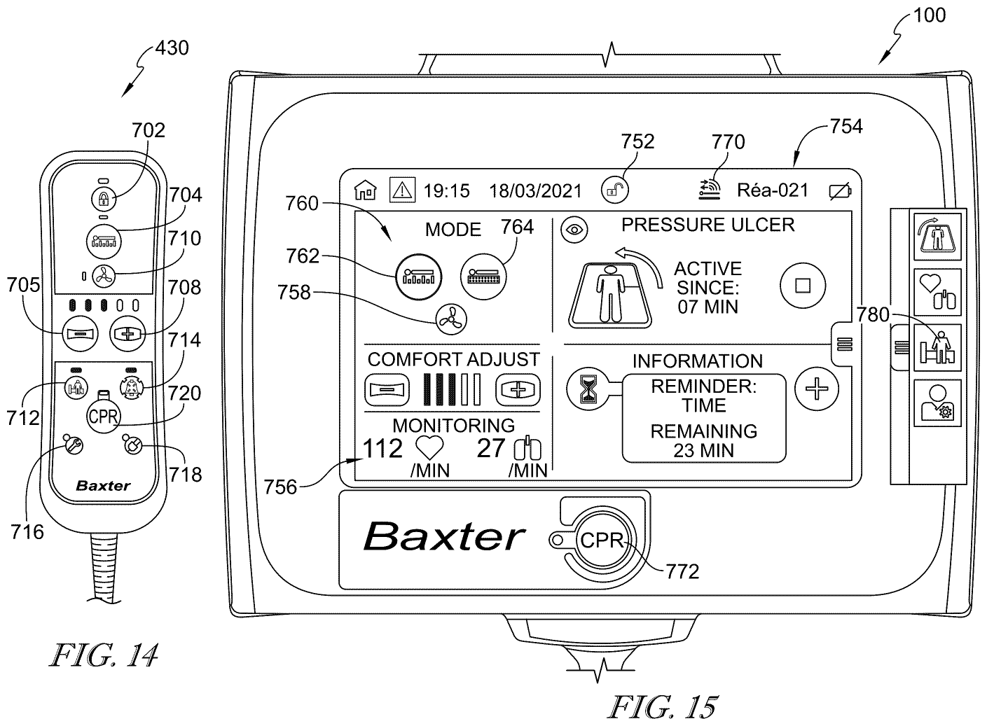

Referring to FIG. 14, the control pendant 430 is usable as any of the control pendants described herein and with any of the mattresses described herein. The control pendant 430 includes a lock/unlock button 702 to lock or unlock the features of the mattress. To avoid accidental changes, the control pendant can be locked by pressing a “lock/unlock” button, so that a light on the pendent turns yellow. After 2 minutes of inactivity, the control pendant locks automatically. If an attempt is made to activate other functions, the light emitting diodes on the control pendant flash to indicate that they are locked.

An alternating pressure mode button 704 activates or deactivates the alternating pressure mode that controls cyclical inflation and deflation of the bladders of the mattress. Buttons 706 and 708 are used to increase or decrease the comfort level of the alternating pressure mode. Another button 712 sets a patient exit alert so that an alarm is triggered when the patient exits the bed. A button 714 inhibits or suspends the alarms associated with the mattress. An indicator 716 is provided to indicate a malfunction or service need. Another indicator 718 operates as a main power indicator.

A button 710 controls the operation of the microclimate management mode. The microclimate management system is configured to reduce the temperature and humidity at the interface between the patient's body and the mattress. Reducing maceration is known to have therapeutic benefits against pressure ulcers and improves the comfort of the patient. The microclimate management system can be activated or deactivated by pressing the microclimate management button 710 on the control pendant. When the microclimate management system is active, the light turns green. When the microclimate management system is off, the light goes out. In some embodiments, the microclimate management system is activated automatically when the mattress is switched on for the first time, or after restarting, if the function was active.

A CPR function of the mattresses can be activated by pressing a CPR button 720, even when the control pendant is locked. The control pendant will be automatically unlocked when a patient exit or malfunction alarm sounds, so that the caregiver can suspend the sound signal. Pressing the button 720 again, unlocks the control pendant and the light goes off.

FIG. 15 illustrates the pendant 100 is usable as any of the control pendants described herein and with any of the mattresses described herein. The pendant 100 controls various functions of the mattress. To lock or unlock the screen of the pendant 100, the lock symbol 752 at the top of the screen is pressed and the user slides their finger downwards. If the screen is not touched for 2 minutes when it is unlocked, the screen will return to the home screen and lock automatically. If the screen is not touched for another 8 minutes, the screen switches itself off.

In some embodiments, the plurality of bladders of the mattress are controlled to rotate a patient on the mattress using a screen of selection area 754 of the display having a plurality of buttons. In some embodiments, the plurality of bladders are controlled to prevent pressure sores in a patient on the mattress. In some embodiments, the display includes at least one screen or selection area 756 for displaying a respiratory rate and heart rate of a patient on the mattress. In some embodiments, the display includes at least one screen or selection area 758 for controlling the microclimate management system of the mattress.

In some embodiments, the display includes at least one screen or selection area 760 for controlling the mode, for example, the alternating pressure mode of the mattress. In the alternating pressure mode, an internal pressure of the different zones of the mattresses varies, alternately creating zones of high and low pressure under the patient's body. The bladders inflate and deflate alternately in a complete cycle lasting about 11 minutes. In some embodiments, optimal regulation occurs when the patient is in the center of the mattress, aligned with the hip position indicator on the bed and the comfort level is set to 3. The function can be activated or deactivated by pressing the alternating pressure button 762 on the control pendent. In a foam mode, the patient lies on a surface made of foam. The foam mode is active when the alternating pressure mode is off or by pressing the foam mode button 764.

In some embodiments, a patient exit alert is used to automatically detect when the patient leaves the mattress. Pre-conditions for activation of the patient exit alert include that the mattress is connected and ready for use, the patient is lying centered on the mattress, and the rotation mode is not activated. Activating the patient exit alert is subject to the above pre-conditions. The sensitivity of the patient exit alert may be affected by raising the thigh section when the head section is flat. The sensitivity of the patient exit alert may vary according to the morphology of the patient and the position of the sleep surface. In some embodiments, there is a delay between the actual exit from the bed and the activation of the alert. In addition, over-detection is possible for lightweight patients during the movements of the bed. The patient exit alert is reactivated once the position of the bed has been set. The patient exit alert can be activated or deactivated by pressing the button 780. When the patient exit alert is active and the patient leaves the bed, three beeps sound through loudspeaker 582, 682 every 3 seconds.

Activating the patient exit alert is subject to the above pre-conditions, for example pressing “Patient Exit” in the home menu or on the icon in the side menu, and pressing the symbol to initialize the “Patient Exit” mode. If the mode cannot be activated, an error message appears and three beeps sound (e.g., patient not present or incorrectly positioned on the mattress). The user then presses “Close” and the activation procedure is repeated. When the patient exit alert is activated and the patient has left the mattress, three beeps sound through loudspeaker 582, 682 every 3 seconds and an alert message flashes on the screen. Pressing “Suspend” on the touch-sensitive screen suspends the alarm and switches the device to the awaiting patient return mode. If the patient returns, the device will try to reactivate the function automatically. When a patient exit alert is raised, a signal is sent over the facility's wireless network to the point where all the information for users is centralized (e.g. a nurse call server and/or master nurse station computer and/or electronic medical record server or computer). Deactivating the patient exit alert requires pressing “Alerts” on the side menu or “Patient exit” in the information section of the home screen. Pressing “Exiting” deactivates the patient exit alert.

If the power supply is disconnected or faulty, the mattress emits three beeps through loudspeaker 582, 682 and the power supply light flashes for 1 minute, then goes out. In the event of a device malfunction (e.g., a pressure fault), the malfunction indicator light near the symbol turns yellow. In the event of a patient exit alert or a malfunction, the button to switch off or suspend the sound alarm can be selected and the green indicator light near the symbol comes on. In some embodiments, if the patient returns, the device reactivates the function automatically.

In some embodiments, the pendant 100 includes a wireless (Wi-Fi) indicator 770. The purpose of the wireless connection is to send data from the mattress to the hospital network for remote display. The status of the wireless connection is displayed in a status bar of the screen. The status includes “Wi-Fi OFF,” “Wi-Fi ON but pairing incomplete,” “Wi-Fi ON with a weak Wi-Fi signal with a validated patient identity,” “Wi-Fi ON with an intermediate Wi-Fi signal with a validated patient identity,” “Wi-Fi ON with a strong Wi-Fi signal with a validated patient identity,” “Mattress located with a non-validated patient identity,” and “Mattress located and patient identified.”

The list of information that can be sent by Wi-Fi includes mattress power supply: connected to a power supply or a battery and battery status; Wi-Fi status ON/OFF; type of mattress; location of the device; presence of the patient on the mattress; patient identity validated or not; status of the CPR mode; current mode: alternating pressure or foam; status of the microclimate management mode; patient exit alert: on, alert, and alert suspended; status of the mobilization mode: on, elapsed time, remaining time, 30-minute alert, alert suspended, angle and side status; status of the pressure ulcer mode: manual, automatic, elapsed time, remaining time, reminder alert, alert suspended, angle and side status; heart rate; respiratory rate; heart rate and respiratory rate threshold alerts; set threshold level; heart rate and respiratory rate alerts suspended; ON/OFF status; Wi-Fi status server connection status; mattress location status; ON/OFF button; and patient identification status.

The process for locating the mattress includes checking that the “Manual location” mode is active. When the Wi-Fi is not activated, the procedure includes pressing the “Connectivity” symbol in the status bar or the icon in the side menu, then pressing the “Connectivity” button in the Nurse menu. The Wi-Fi connection is then activated and the user waits for the connection with the server. When the Wi-Fi is activated and connected to the server, the procedure includes pressing the “Locate” symbol, selecting the location of the room in the facility, and selecting the room number from the list of available locations, or another location, by pressing “Different Location.” The location process checks that the selected room is available. When the server has identified the room and the room number appears, if the room is already assigned to an assigned device, a screen opens. The process includes pressing “Continue” to force the system to accept the location, or a different room. By forcing the system to accept the location, the mattress already assigned to the location will be informed by two beeps and a visual warning that its location has been lost. If the selected location is unavailable, the “Assigned Room List” is selected to identify the bed's location.

The mattress location procedure is only possible if the following three conditions are met: the device has been located, the server proposes a patient name for the room, and the patient is on the mattress. The process for confirming patient identity includes pressing the “Connectivity” symbol in the status bar or the icon in the side menu, and then pressing the “Connectivity” symbol in a Nurse menu. The “Check identity” button is then pressed. If the patient identity is correct, confirmation is made by pressing “Yes.” If the patient identity is not correct, the user presses “No.” If the “Patient Name Encoding” function is deactivated, the patient's full name and date of birth appears at all times. If the “Patient Name Encoding” function is activated, the patient's full name and date of birth only appears during the first identity confirmation and then the name will be encrypted. The patient identity is then assigned to the mattress. The patient name and date of birth are automatically in the unverified status if the mattress is in battery mode or if the patient has left the mattress. After 24 consecutive hours in battery mode or without a patient on the mattress, the patient identity will be set to the unverified status. The patient's name must then be validated. To set the patient identity verification status to “unverified”, a function that erases data between two patients is used. If the system used to enter information in the facility's electronic patient file is configured to use the verification function, when the patient's name is validated, it is possible to automatically send and save certain information about the patient (e.g., heart rate, respiratory rate). In some embodiments, the “correct,” “incorrect,” or “not verified” information of the mattress regarding the patient's identity does not modify the patient's identity information in the hospital's electronic medical file. It is only a status associated with the patient identity.

If the mattress becomes disconnected from the power supply, for example, because of a transfer or because the electrical power supply is cut, the mattress is automatically reconnected in the same room when the power supply is restored if the power is disconnected for less than one minute. If the power is disconnected for more than 1 minute and the bed is returned to the same room, the screen on the mattress shows the room where the bed was previously located. The user then presses “Yes” to confirm. If the power is disconnected for more than 1 minute and the bed is transferred to another room, the screen on the mattress shows the room where the bed was previously located. The user then presses “Different Room” to choose another room. The new room is selected in the list. If the room is already assigned to a mattress, a screen opens. The user presses “Continue” to force the system to accept the location, or the user presses “Different Room” to select a location. By forcing the system to accept the location, the mattress already assigned to the location will be informed that its location has been lost. If the selected location is unavailable, the user selects the “Assigned Room List” to identify the location.

A CPR button 772 is provided, as shown in FIG. 15. When it is necessary to return the mattress to the flat position in the event of an emergency, opening the CPR valve by pressing the CPR button 772 quickly deflates the mattress, providing flat and hard surface for external heart massages. If necessary, the user lowers the siderails and the head section of the bed or places the bed frame in the CPR position. If the user presses the CPR button 720 on the control pendant 430 for at least 1 second the CPR mode activate and the indicator light near the CPR symbol turns yellow. During the first 30 seconds required for deflation, the indicator light flashes and two beeps sound every 15-20 seconds. Then the indicator light remains on until the mode is switched off. The mattress then switches to foam mode. Pressing the CPR button again or pressing “Cancel” on the pendant 100 cancels the CPR mode. The mattress restarts by completing an initialization cycle. The mattress reverts to the preceding therapeutic mode. If necessary, the bed frame is returned to the appropriate position. The mattress CPR only functions if the mattress is plugged into a power source.

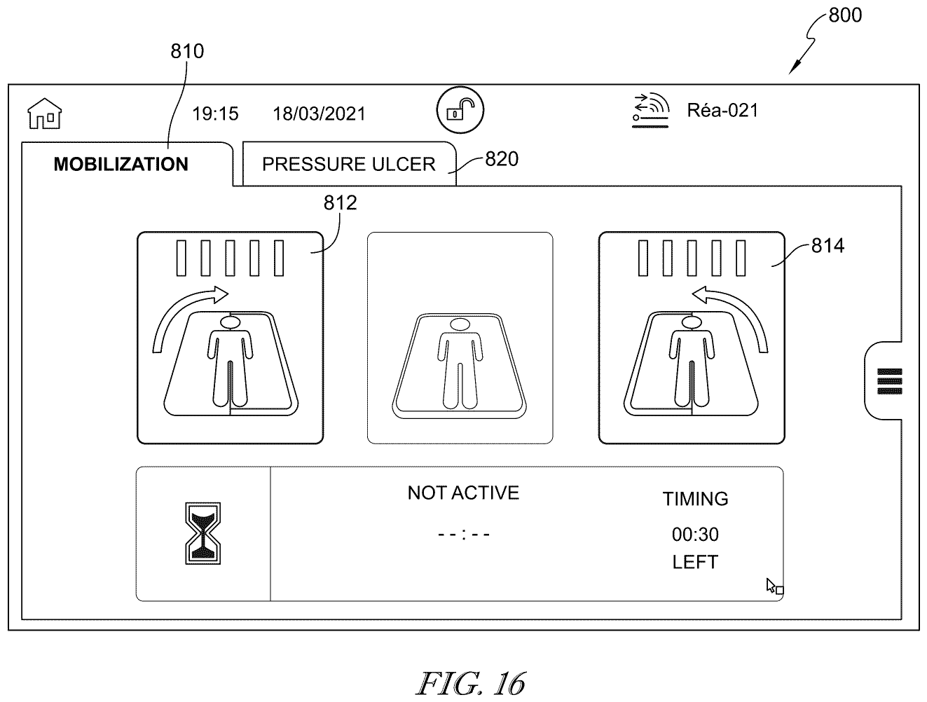

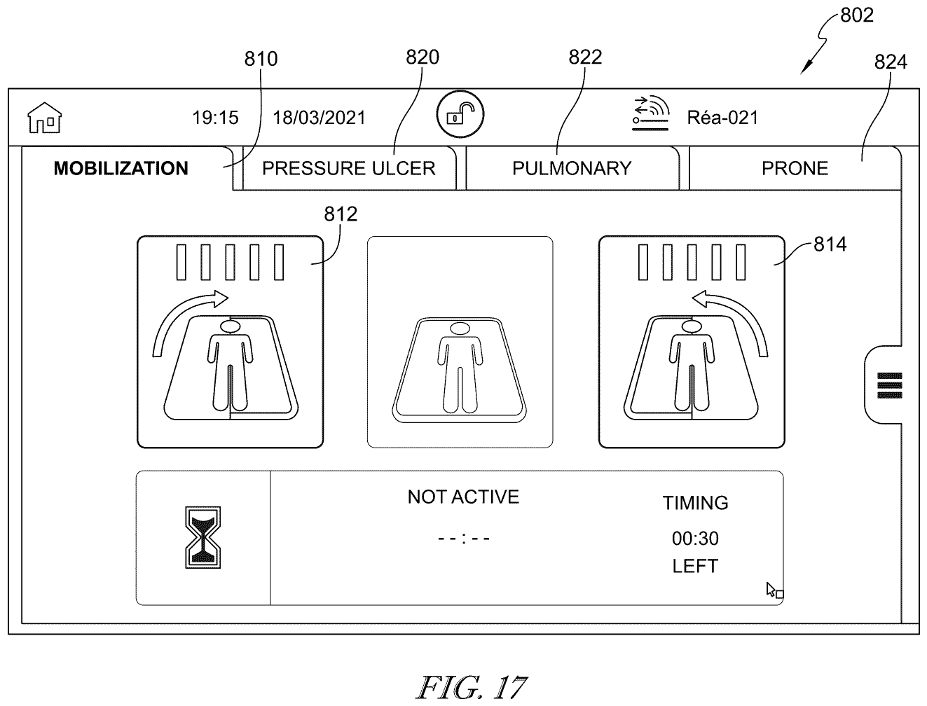

Referring now to FIGS. 16 and 17, screens 800 and 802 of the pendant 100 control the plurality of bladders to rotate the patient. A mobilization setting 810 (shown) enables the user to rotate the patient right or left by selecting the button 812 or 814. The mattress automatically switches to foam mode during the rotation phases to prevent the patient from sliding. The user chooses the side to which the patient will be turned. The mobilization of the patient starts as soon as the corresponding control is pressed. The zone of the mattress that will be inflated is highlighted. Side inflation stops as soon as the control is released. The mode then remains active for 30 minutes. The elapsed time and remaining time are displayed on the mobilization function settings screen and the home screen.

A pressure ulcer setting 820 activates the bladders to periodically rotate the patient to prevent pressure sores or ulcers. The zone of the mattress that will be inflated is highlighted. The required angle (e.g., maximum) is selected and the corresponding side of the mattress is inflated until the selected angle is reached. The pressure ulcer mode is then active. By default, a 2-hour timer then starts. The time spent by the patient in the pressure ulcer mode position can be set to between 30 minutes and 4 hours. In screen 802, a pulmonary setting 822 and a prone setting 824 are also selectable to control the bladders of the mattress.

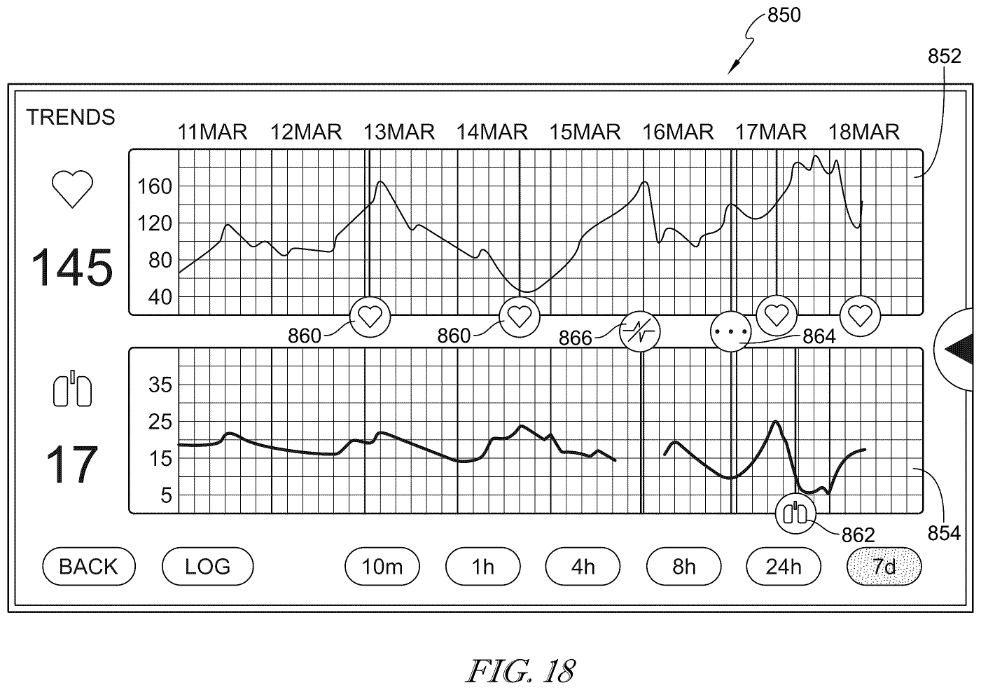

FIG. 18 illustrates another exemplary display screen 850 that is displayed on the pendant 100. The screen 850 illustrates a heart rate graph 852 and a respiratory rate graph 854 of the patient. On the heart rate graph 852 a symbol 860 indicates that the system has recorded and saved the patient's heart rate. On the respiratory rate graph 854 a symbol 862 indicates that the system has recorded and saved the patient's respiratory rate. A symbol 864 indicates that multiple simultaneous alerts have occurred. A symbol 866 indicates that the heart rate and/or respiratory rate was lost. In some embodiments, another symbol indicates that troubleshooting is required for the heart rate and/or respiratory rate monitor/sensor.

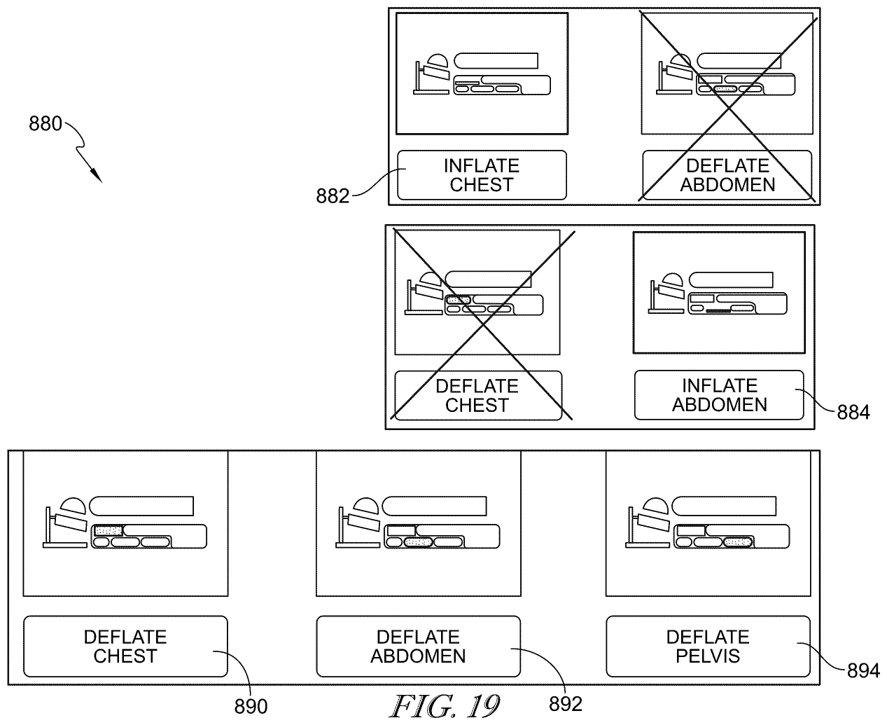

Referring to FIG. 19, a display screen 880 of the pendant 100 controls the inflation and deflation of the plurality of bladders. In some embodiments, an inflate chest bladders button 882 is only operable if the abdomen bladders cannot be deflated. In some embodiments, an inflate abdomen bladders button 884 is only operable if the chest bladders cannot be deflated. In an exemplary embodiment, the screen 880 includes a button 890 to deflate the chest bladders, a button 892 to deflate the abdomen bladders, and a button 894 to deflate the pelvis bladders.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

When terms of degree such as “generally,” “substantially,” and “about” are used herein in connection with a numerical value or a qualitative term susceptible to a numerical measurement, it is contemplated that an amount that is plus or minus 10 percent, and possibly up to plus or minus 20 percent, of the numerical value, is covered by such language, unless specifically noted otherwise, to at least account for manufacturing tolerances. Otherwise, a suitable definition for “generally,” “substantially,” and “about” is largely, but not necessarily wholly, the term specified.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used, the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles have been presented, they need not be utilized in combination, and many combinations of aspects and principles are possible in light of the various embodiments provided above.

1. A video display interface comprising:
a first component having:
a first circuit board,
a microprocessor electronically coupled to the first circuit board, and
a serializer electronically coupled to the first circuit board and configured to receive a first plurality of signals from the microprocessor,
a second component having:
a second circuit board,
a plurality of electronic components electronically coupled to the second circuit board, and
a deserializer electronically coupled to the second circuit board and configured to transmit a second plurality of signals to the plurality of electronic components, and
a coiled cable having:
at least one wire, wherein the serializer converts the first plurality of signals into a serial data signal that is transmitted through the at least one wire to the deserializer, and wherein the deserializer converts the serial data signal into the second plurality of signals, and
a shield surrounding the at least one wire to protect the plurality of electronic components from interference.

2. The interface of claim 1, wherein at least one of the plurality of electronic components is a video display, wherein at least one of the plurality of first signals and at least one of the plurality of second signals is a video signal.

3. The interface of claim 2, wherein the video display includes at least one of a low-voltage differential signaling (LVDS) display and a red, green, blue (RGB) display.

4. The interface of claim 2, wherein the shield prevents electromagnetic compatibility (EMC) perturbations on the video display.

5. The interface of claim 1, wherein the at least one wire includes six conductive wires, only two of which are for transmission of the serial data signal, and a drain wire.

6. The interface of claim 1, wherein:
the first component is a mattress, and
the second component is a handheld pendant configured to control operation of the mattress.

7. The interface of claim 1, wherein:
the first circuit board includes a first communication port, and
the second circuit board includes a second communication port;
wherein the coiled cable extends between the first communication port and the second communication port.

8. The interface of claim 1, wherein the cable includes:
a first connector configured to couple to the first circuit board,
a second connector configured to couple to the second circuit board, and
a fixation device configured to couple the cable to the first component.

9. The interface of claim 8, wherein:
the first connector extends from the fixation device, and
a length that the first connector extends from the fixation device is adjustable.

10. A video display interface comprising:
a first component having:
a microprocessor, and
a serializer configured to receive a first plurality of signals from the microprocessor,
a second component having:
a video display, and
a deserializer configured to transmit a second plurality of signals to the video display, and
a coiled cable having at least one wire, wherein the serializer converts the first plurality of signals into a serial data signal that is transmitted through the at least one wire to the deserializer, wherein the deserializer converts the serial data signal into the second plurality of signals, and wherein at least one of the plurality of first signals and at least one of the plurality of second signals is a video signal.

11. The interface of claim 10, wherein the video display includes at least one of a low-voltage differential signaling (LVDS) display and a red, green, blue (RGB) display.

12. The interface of claim 10, wherein the at least one wire includes six conductive wires, only two of which are for transmission of the serial data signal, and a drain wire.

13. The interface of claim 10, wherein:
the first component is a mattress, and
the second component is a handheld pendant configured to control operation of the mattress.

14. The interface of claim 10, wherein:
the first component includes a first communication port, and
the second component includes a second communication port;
wherein the coiled cable extends between the first communication port and the second communication port.

15. The interface of claim 10, wherein the cable includes:
a first connector configured to couple to a first circuit board of the first component,
a second connector configured to couple to a second circuit board of the second component, and
a fixation device configured to couple the cable to the first component,
wherein the first connector extends from the fixation device, and
wherein a length that the first connector extends from the fixation device is adjustable.

16. A video display interface comprising:
a mattress having:
a microprocessor, and
a serializer configured to receive a first plurality of signals from the microprocessor,
a handheld pendant configured to control operation of the patient support apparatus, the handheld pendant having:
a video display, and
a deserializer configured to transmit a second plurality of signals to the video display, and
a coiled cable having:
at least one wire, wherein the serializer converts the first plurality of signals into a serial data signal that is transmitted through the at least one wire to the deserializer, wherein the deserializer converts the serial data signal into the second plurality of signals, and wherein at least one of the plurality of first signals and at least one of the plurality of second signals is a video signal, and
a shield surrounding the at least one wire to prevent electromagnetic compatibility (EMC) perturbations on the video display.

17. The interface of claim 16, wherein the video display includes at least one of a low-voltage differential signaling (LVDS) display and a red, green, blue (RGB) display.

18. The interface of claim 16, wherein the at least one wire includes six conductive wires, only two of which are for transmission of the serial data signal, and a drain wire.

19. The interface of claim 16, wherein:
the mattress includes a first communication port, and
the handheld pendant includes a second communication port;
wherein the coiled cable extends between the first communication port and the second communication port.

20. The interface of claim 16, wherein the cable includes:
a first connector configured to couple to the first communication port,
a second connector configured to couple to the second communication port, and
a fixation device configured to couple the cable to the first component,
wherein the first connector extends from the fixation device, and
wherein a length that the first connector extends from the fixation device is adjustable.
